(19) United States
(12) Patent Application Publication
(10) Pub. No.: US 2023/0277414 A1
(43) Pub. Date: Sep. 7, 2023

(54) ACUPRESSURE TOOL

(71) Applicants: Young Hee KANG, Seoul (KR); Jin Ho BAE, Seoul (KR)

(72) Inventors: Young Hee KANG, Seoul (KR); Jin Ho BAE, Seoul (KR)

(21) Appl. No.: 18/016,458

(22) PCT Filed: Jul. 5, 2021
(86) PCT No.: PCT/KR2021/008468

§ 371 Date: Jan. 17, 2023

(30) Foreign Application Priority Data
Jul. 27, 2020 (KR) 10-2020-0093231

(51) Int. Cl. A61H 39/04

(52) U.S. Cl. CPC A61H 39/04

(57) ABSTRACT

The present invention relates to an acupressure tool, and in particular, an acupressure tool in which one end of a rod-shaped acupressure body is bent toward one direction to form a first pressing part so that the acupuncture point located deeply in a human body can be easily stimulated even with a small force, and the first pressing part is formed to gradually decrease in width toward a tip, and is able to press an acupuncture point through the first pressing part on the principle of a lever.

### TECHNICAL FIELD

The present invention relates to an acupressure tool, and more particularly, to an acupressure tool capable of pressing an acupuncture point.

### BACKGROUND ART

In general, acupressure refers to a manual therapy that facilitates circulation of blood to promote health, and cures diseases, by pressing a certain part of a body surface with a thumb, a palm or the like.

In addition, a painful point refers to a point that feels more sensitive when pressed within a part where pain is felt. Here, a ‘ow’ is an onomatopoeia, which expresses a voice spit out as ‘ouch’ or ‘ow’ when pressing a pressure point. In other words, the meaning of the term ‘painful point’ means that the diseased part becomes an acupuncture point when pressed.

The painful point is similar to TP (Trigger Point) therapy in Western medicine. The TP therapy is a technique of practicing acupressure a trigger point (harder and more sensitive than periphery and a pain spreads to periphery) which occurs in skeletal muscle or fascia when a muscle is excessively strained, or treating the trigger point with a needle. If somebody has pain, a pain relief effect can be attained when applying acupuncture on the painful point or massaging it.

The hand is a scaled-down plate of the human body, and parts of the human body correspond to the inside of the hand. When a painful symptom occurs in the human body, the symptom also occurs in the hand. Accordingly, the corresponding human body part appearing on the hand is stimulated, and is utilized as an adjuvant therapy for mild symptom management and disease treatment. In particular, a convoluted point, which is an innermost recessed part of the hand between the thumb and index finger, is known as the acupuncture point suitable for improving digestion and relieving symptoms such as headaches, menstrual cramps, rhinitis, and acute dyspepsia.

Hands are used and various forms of acupressure tools are used to stimulate various acupuncture points. However, it takes a lot of force to stimulate the acupuncture point with the hand, and even if the acupuncture point is stimulated with a ball-shaped or simple stick-shaped acupressure tool, there is a problem that takes a lot of force in stimulating the acupuncture point that is located deeply like the convoluted point.

### DISCLOSURE

### Technical Problem

The present invention is to resolve the above problem, and an object of the present invention is to provide an acupressure tool that can easily stimulate the acupuncture point located deeply in the human body with a small amount of force.

### Technical Solution

In the acupressure tool of the present invention for achieving the above object, one end of a rod-shaped acupressure body is bent toward one direction to form a first pressing part, and the first pressing part is formed to gradually decrease in width toward a tip.

Also, a spherical hitting ball may be provided at the other end of the acupressure body to protrude in one direction.

Also, a third pressing part having a columnar shape and having a blunt tip may be formed to protrude at the other end of the acupressure body, and the hitting ball may be detachably fitted to the third pressing part.

Further, the other end of the acupressure body may be bent toward the other direction to form a second pressing part, and the second pressing part may be formed to have a tip which is convex outward, and have a gentler curvature than the tip of the first pressing part.

Also, the acupressure body may further include a counting member capable of counting the number of times of pressing the acupuncture point through the first pressing part.

### Advantageous Effects

According to the present invention, after the acupuncture point to be acupressure is positioned under a first pressing part, the other end side of the acupressure body is fixed, and then the first pressing part can be used while pressing the acupuncture point to stimulate it, using the principle of the lever. Accordingly, it is possible to easily stimulate the acupuncture points such as the convoluted point that is deeply located in the human body with a small amount of force.

In addition, the percussion ball, the third pressing part, the second pressing part, and the like can be used to apply a suitable stimulation to the acupuncture point, and various acupuncture points can be effectively stimulated.

### DESCRIPTION OF DRAWINGS

FIG. 1 is a perspective view showing a structure according to an embodiment of an acupressure tool according to the present invention.

FIG. 2 is a front view showing the structure according to an embodiment of an acupressure tool according to the present invention.

FIG. 3 is an exploded perspective view showing the structure according to an embodiment of an acupressure tool according to the present invention.

FIG. 4 is a perspective view showing the structure according to another embodiment of an acupressure tool according to the present invention.

FIG. 5 is a front view showing the structure according to another embodiment of an acupressure tool according to the present invention.

FIGS. 6 and 7 are exemplary diagrams showing a state of stimulating the acupuncture point through the first pressing port applied to the acupressure tool according to the present invention.

FIG. 8 is an exemplary view showing a state of massaging performed through a hitting ball applied to the acupressure tool according to the present invention.

FIG. 9 is an exploded perspective view showing the structure according to another embodiment of an acupressure tool according to the present invention.

FIG. 10 is an exemplary view showing a state of stimulating an acupuncture point through a third pressure port applied to an acupressure tool according to the present invention.

FIG. 11 is an exemplary view showing a state of stimulating the acupuncture point through the second pressing port applied to the acupressure tool according to the present invention.

FIG. 12 is a perspective view showing the structure according to another embodiment of an acupressure tool according to the present invention.

### BEST MODE

The present invention proposes an acupressure tool in which one end of a rod-shaped acupressure body is bent toward one direction to form a first pressing part so that the acupuncture point located deeply in the human body can be easily stimulated with a small force, the first pressing part is formed to have a width which gradually decreases toward a tip, and the acupuncture point can be pressed through the first pressing part on the principle of a lever.

The scope of rights of the present invention is not limited to the embodiments described below, and various modifications can be made by those skilled in the art without departing from the technical scope of the present invention.

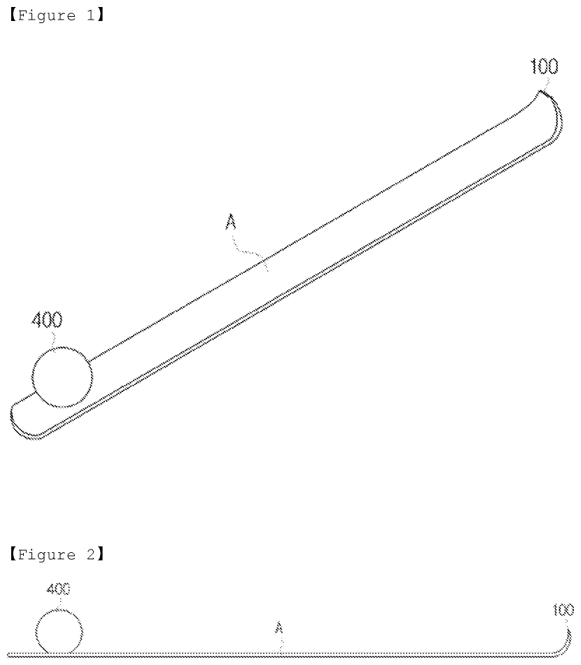

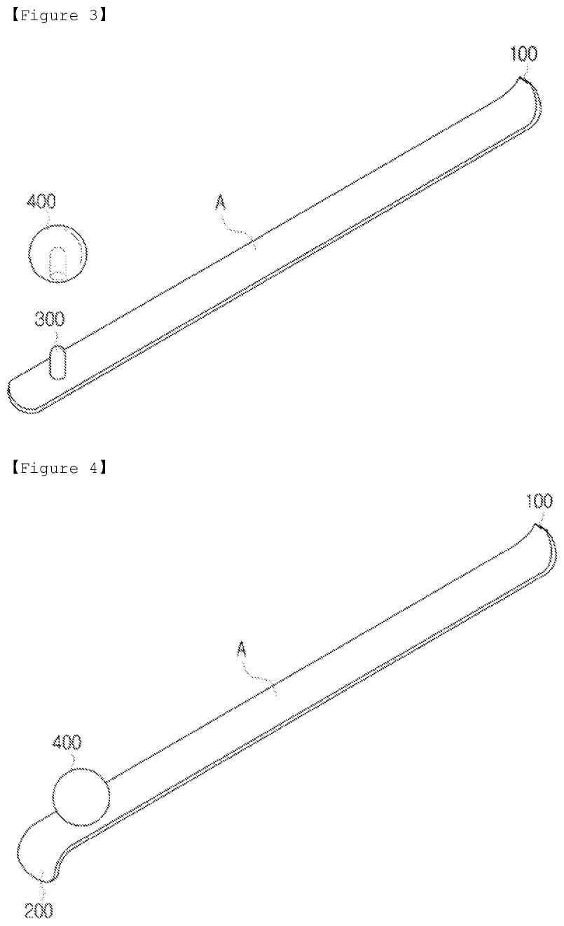

Hereinafter, the acupressure tool of the present invention will be described in detail with reference to the accompanying FIGS. 1 to 12.

The acupressure tool of the present invention includes a rod-shaped acupressure body A as shown in FIGS. 1 to 5, and the acupressure body A is formed with a thin thickness, while having a predetermined width and length, and can be formed in the form similar to a ‘back scratcher’. Further, when considering that the present invention is used using the principle of the lever, the acupressure body A is preferably made of a material that is robust and has some elasticity.

As shown in FIGS. 1 to 5, the acupressure body A has one end bent in one direction to form a first pressing part 100. At this time, the first pressing part 100 is formed to achieve a direction orthogonal to a longitudinal direction of the acupressure body A or a direction close to a direction orthogonal to the longitudinal direction of the acupressure body A so that the acupuncture point can be pressed through the tip. In addition, although a portion between the tip of the first pressing part 100 and the acupressure body A may be bent in an angled shape, it is preferably bent in the form of a curved surface so that an injury can be prevented and solidity can be maintained when in use.

The first pressing part 100 is formed to have a width that gradually reduces toward the tip. In addition, it is preferable that the tip of the first pressing part 100 be formed to be blunt when viewed from the front and to be sharp when viewed from the side so as to be suitable for stimulating the acupuncture point. Therefore, the user can use the tool while pressing to position the acupuncture point to be subjected to acupressure on the lower side of the first pressing part 100, fix the other end of the acupressure body A, and then stimulate the acupuncture point with the first pressing part 100 using the principle of the lever. Accordingly, it is also possible to easily stimulate the acupuncture point such as convoluted point located deeply in the human body with a small force.

As a first example of use, as shown in FIG. 6, when a user wants to stimulate the acupuncture point of the left hand, the user places the left hand on the left leg in a seated state, and the acupressure body A crosses both legs to position the first pressing part 100 on the left hand. After that, after the other end of the acupressure body A is axially fixed, the acupressure body A adjacent to the first pressing part 100 is moved up and down with the right hand so that the first pressing part 100 can stimulate the acupuncture point.

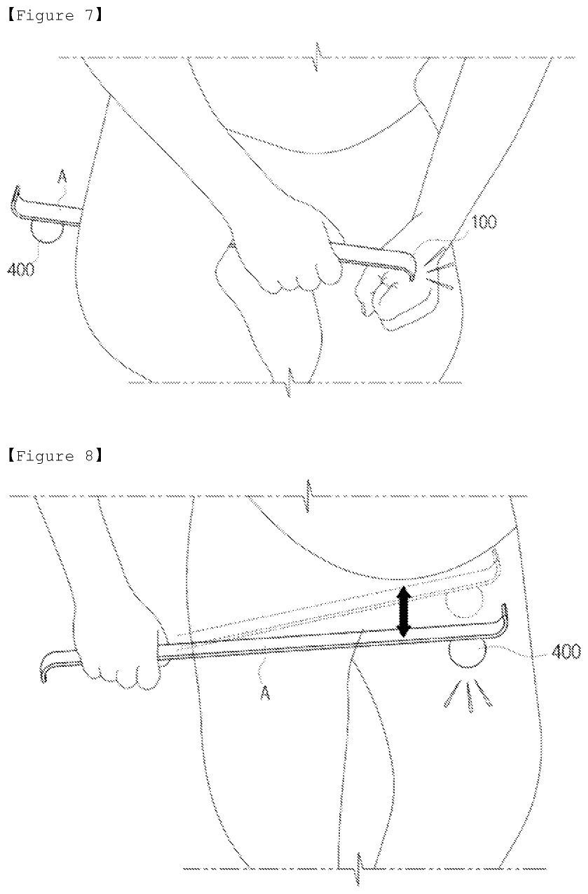

As a second example of use, as shown in FIG. 7, when the user wants to stimulate the acupuncture point of the left hand, the user places the left hand on the left leg in a seated state, and the acupressure body A is positioned under the right leg, at the same time, the first pressing part 100 is positioned on the left hand. After that, while the other end of the acupressure body A is axially fixed by the right leg, the part of the acupressure body A adjacent to the first pressing part 100 is moved up and down with the right hand so that the first pressing part 100 can stimulate the acupuncture point.

As a third example of use, when the user wants to stimulate the acupuncture point of the left hand, the first pressing part 100 is placed on the left hand while the acupressure body A is sandwiched between the legs while lying on the left side. Thereafter, after the other end of the acupressure body A is axially fixed, the acupressure body A portion adjacent to the first pressing part 100 is grasped with the right hand, and the gripped right hand is repeatedly pressed with the right leg so that the first pressing part 100 can stimulate the acupuncture point.

On the other hand, the acupressure body A can have a spherical hitting ball 400 as shown in FIGS. 1 to 5, and the user can use the hitting ball 400 to massage him as shown in FIG. 8. The hitting ball 400 can be provided at various positions on the acupressure body A, but is preferably provided at the other end of the acupressure body A to protrude in one direction. Thus, the hitting ball 400 protruding in one direction from the other end of the acupressure body A can be utilized for axially fixing the other end of the acupressure body A, when pressing the first pressing part 100 using the principle of the lever.

As an example of utilization of the hitting ball 400, as shown in FIG. 6, the hitting ball 400 can be positioned outside adjacent to the right leg in the first example of use, and the hitting ball 400 can be positioned at a rear side adjacent to the left leg in the third example of use. The hitting ball 400 positioned in this way is engaged with the adjacent legs to serve to axially fix the other end of the acupressure body A, and the first pressing part 100 can be used more efficiently to stimulate the acupuncture point.

Such a hitting ball 400 can be attached to the acupressure body A via an adhesive or the like. It is preferable that the ball 400 be detachably attached to the acupressure body A in consideration of replacement with the ball 400 or the like.

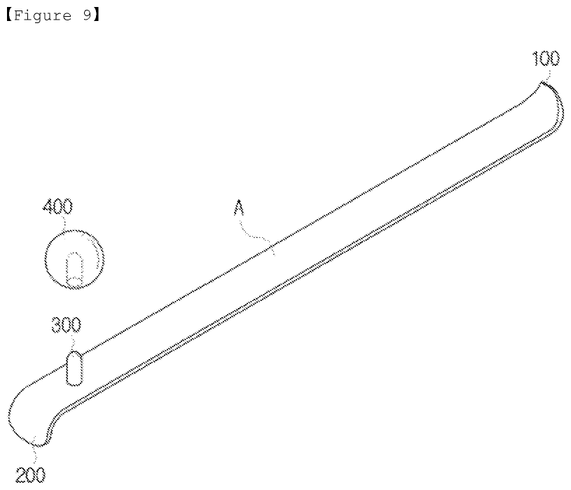

As an example, as shown in FIG. 9, a columnar third pressing part 300 may be formed to protrude from the other end of the acupressure body A, and the hitting ball 400 can be detachably fitted into the third pressing part 300. It is preferable that the third pressing part 300 be formed to have a height lower than the protruding height of the hitting ball 400 from the acupressure body A so that the hitting ball 400 can be interference-fitted.

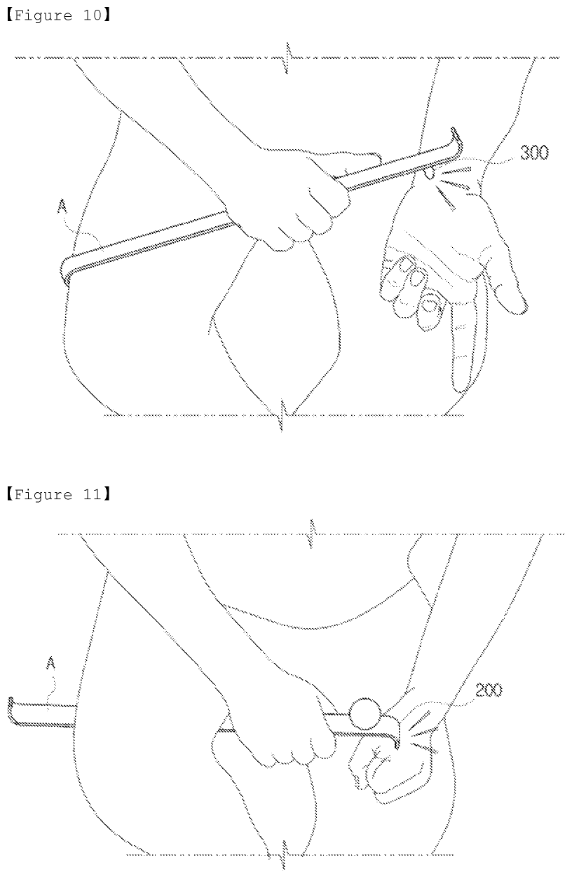

Further, the third pressing part 300 can be formed so that the user separates the hitting ball 400 and can stimulate the acupuncture point using the third pressing part 300. As an example, the third pressing unit 300 can be formed to have a blunt end. That is, as shown in FIG. 10, the user can stimulate the acupuncture point using the third pressing part 300 formed in the same shape as a bullet, as in the first to third example of uses and the like.

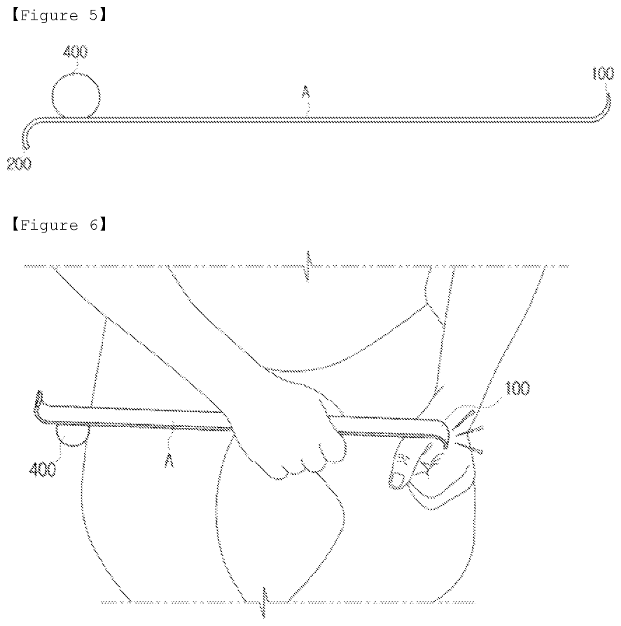

As shown in FIGS. 1 to 3, the other end of the acupressure body A can be formed with a straight line, and it is possible to apply acupressure between the toes and the like using the straight other end of the acupressure body A. Also, as shown in FIGS. 4 and 5, the other end of the acupressure body A can be bent toward the other direction opposite to the first pressing part 100 to form the second pressing part 200. At this time, similarly to the first pressing part 100, the second pressing part 200 is formed to achieve a direction perpendicular to the longitudinal direction of the acupressure body A or a direction close to a direction perpendicular to the longitudinal direction of the acupressure body A so that the acupuncture point can pressed through the tip. Also, although the portion between the tip of the second pressing part 200 and the acupressure body A can be bent in an angled shape, it is preferable to be bent in the form of a curved surface so that injury can be prevented and solidity can be maintained when use.

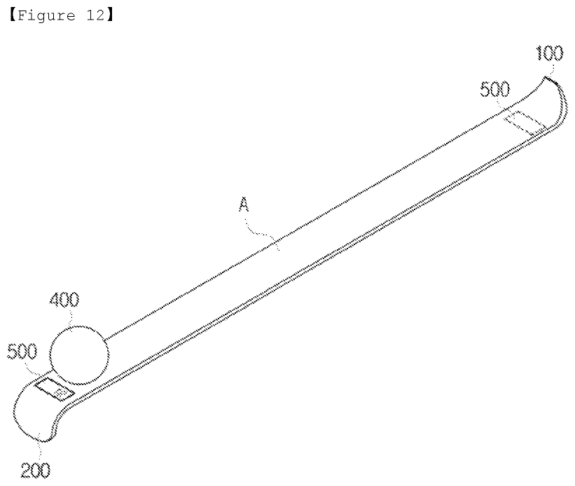

The tip of the second pressing part 200 can be formed to have a gentler curvature than the tip of the first pressing part 100, while being convex outward. That is, the second pressing part 200 can press the acupuncture point in a wider range than the first pressing part 100 when stimulating the acupuncture point. That is, as shown in FIG. 11, the user can stimulate the acupuncture point using the second pressing part 200, as in the first to third examples of use.

Through the present invention described above, the user can apply suitable stimulus to the acupuncture point, by selectively using any one of the first pressing part 100, the second pressing part 200, the third pressing part 300, and the hitting ball 400, and thus can effectively stimulate various acupuncture points.

On the other hand, as shown in FIG. 12, the acupressure body A may further include a counting member 500 capable of counting the number of times of pressing the acupuncture point by one of the first pressing part 100, the second pressing part 200, and the third pressing part 300 or the number of times of hitting the acupuncture point by the hitting ball 400, and the counting member 500 may be provided on one end side and/or the other end side of the acupressure body A, respectively. As a result, the user can easily grasp the number of times of pressing the acupuncture point and the number of times of hitting the body, and can gradually increase the number of times of pressing or hitting, or adjust the number of times of pressing or hitting every minute to perform more systematic acupressure.

### Sequence List Free Text

### DESCRIPTION OF SYMBOLS

A: Acupressure body
100: First pressing part
200: Second pressing part
300: Third pressing part
400: Hitting ball

1. An acupressure tool,
wherein one end of a rod-shaped acupressure body (A) is bent toward one direction to form a first pressing part (100), and
the first pressing part (100) is formed to gradually decrease in width toward a tip, and is able to press an acupuncture point through the first pressing part (100) on the principle of a lever.

2. The acupressure tool according to claim 1,
wherein a spherical hitting ball (400) is provided at the other end of the acupressure body (A) to protrude in one direction.

3. The acupressure tool according to claim 2,
wherein a third pressing part (300) having a columnar shape and having a blunt tip is formed to protrude at the other end of the acupressure body (A), and
the hitting ball (400) is detachably fitted to the third pressing part (300).

4. The acupressure tool according to claim 2,
wherein the other end of the acupressure body (A) is bent toward the other direction to form a second pressing part (200), and
the second pressing part (200) is formed to have a tip which is convex outward, and have a gentler curvature than the tip of the first pressing part (100).

5. The acupressure tool according to claim 1,
wherein the acupressure body (A) further comprises a counting member (500) capable of counting the number of times of pressing the acupuncture point through the first pressing part (100).
